(19) United States
(12) Patent Application Publication
(10) Pub. No.: US 2025/0200303 A1
(43) Pub. Date: Jun. 19, 2025

(54) METHOD FOR MODEL OF CONSTRUCTION A VIETNAMESE MACHINE TRANSLATION BY USING SYNTACTIC INFORMATION

(71) Applicant: VIETTEL GROUP, Ha Noi City (VN)

(72) Inventors: Xuan Dung Doan, Gia Binh District (VN); Ngoc Dung Nguyen, Ha Noi City (VN)

(73) Assignee: VIETTEL GROUP, Ha Noi City (VN)

(21) Appl. No.: 18/758,142

(22) Filed: Jun. 28, 2024

(30) Foreign Application Priority Data
Dec. 14, 2023 (VN) 1-2023-08941

(51) Int. Cl. G06F 40/58; G06F 40/211; G06F 40/284; G06F 40/289

(52) U.S. Cl. CPC G06F 40/58; G06F 40/211; G06F 40/284; G06F 40/289

(57) ABSTRACT

The invention provides a method to build a machine translation model using syntactic information from another language to Vietnamese and vice versa. Specifically, the invention enhances machine translation quality by incorporating syntactic information into the model. Current machine translation models in the market learn syntactic information as features during the training process. However, this approach may not capture sufficient syntactic information, leading to inaccuracies in translation and contextual errors. Therefore, the invention focuses on exploiting syntactic information from the training data, aiming to produce accurate and contextually correct translations.

### TECHNICAL FIELD

This application relates to a Vietnamese machine translation method using syntactic information. The invention proposes a method, which focuses on integrating syntactic information of Vietnamese sentence into the machine translation model.

### BACKGROUND OF THE INVENTION

Nowadays, the trend of globalization is become increasingly evident in all areas of life. Accompanying this is the explosion of machine translation applications to meet human needs in communication and work. Machine translation is automated process of translating content from one language to another without human intervention for translation process. There are various methods for addressing this issue such as rule-based machine translation, statistical machine translation and neural machine translation. With the remarkable advancement in graphics processing, the neural network methods have become the approach yielding the best translation results and are currently under ongoing research and development.

Research on machine translation primarily focuses on sentence-level translation. Sentence-level translation applications still face numerous challenges in the market, such as inaccuracies in word context and misinterpretation of special vocabulary in fields like healthcare and military. Current machine translation technologies have achieved high performance for language pair with abundant language. However, for languages with limited resource, such as Vietnamese, machine translation must still require further improvement, especially in specialized domains.

### THE NATURE OF THE PATENT

The issue of syntactic analysis within a sentence during translation plays a crucial role in ensuring smooth and accurate translation. In the regard, grammar learning is often conducted automatically in deep learning models, leading to underutilized syntactic structures. Therefore, the purpose of this invention is to enhance syntactic information within the machine translation model.

The use of syntactic analysis in machine translation is a direction that many researchers focus on exploring. Syntactic analysis in natural language processing is mainly divided into two types: constituency parsing and dependency parsing. In the real-world data, constituency parsing is challenging to apply due to the complexity of constructing data for constituency parse trees. On the other hand, dependency parse trees are widely adopted in the community because the construction of training data is simpler compared to constituency parse trees. Therefore, the invention utilizes dependency parsing to incorporate into proposed model.

In addition to utilizing syntactic parsing tools, the invention also proposes the incorporation of an automatic grammar learning module. Each word will be associated with a vector representing its grammatical role in the sentence (subject, predicate, noun, verb, etc). These representation vectors will be connected to the word vectors through multiplication operations. This ensures that the proposed model is not overly dependent on syntactic parsing tools.

In summary, the invention introduces a model that strengthens grammar learning in sentences by incorporating the syntactic information of the sentence through dependency paring tools. The information will be accompanied by the source sentence during training. The method will be designed with the new vectors to learn the syntactic information of target sentence, initialized randomly within the approach. At each layer, the method will compute the connection weights between the grammar vector and the word vector. Subsequently, the method will use multiplication operations to integrate the word and grammar information at each word unit of the sentence. To achieve this purpose, the invention includes the following steps:

Step 1: Collect the machine translation data. The data is gathered from various news websites in textual format, encompassing multiple languages and their corresponding translations.

Step 2: Segment sentences in the text. Determine the boundaries of sentences within a text. The sentences are input for the model training process.

Step 3: Develop an algorithm for aligning sentences across texts. The algorithm helps to identify accurately sentences that correspond to each other between texts.

Step 4: Analysis syntax of sentences. This aids in providing information on the syntactic relationship between words in the sentences, serving as input for machine translation model.

Step 5: Building a machine translation model incorporating syntactic information. The model learns comprehensive syntactic information from the input source sentences and the corresponding translated sentence.

### DESCRIBE BRIEF FIGURE

FIG. 1 describes the steps of the methods.

FIG. 2 provides the detailed graphical representation of machine translation model described in the invention.

### DETAILED DESCRIPTION

The invention is described in connection with the accompanying figures below. The illustration aims to depict the embodiments of the invention without limiting the scope of patent protection.

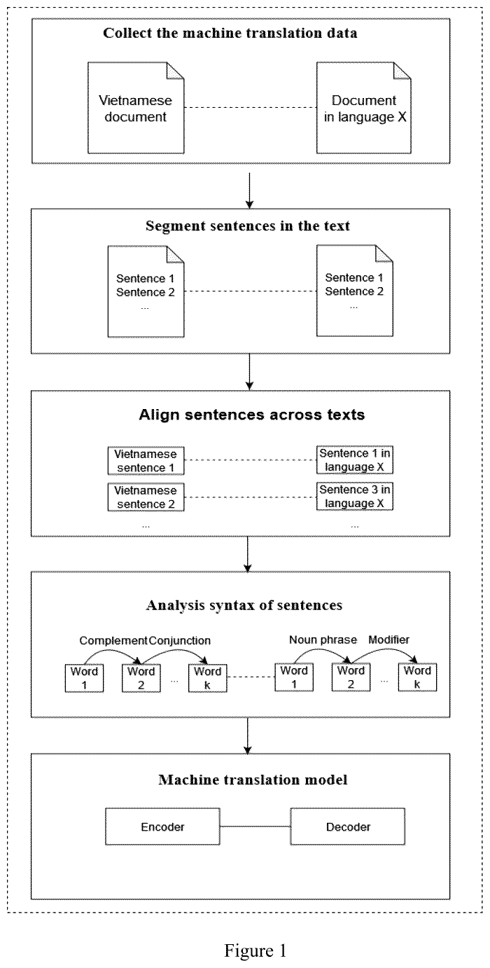

Specially, FIG. 1 describes steps when text is included, such as:
i) Collect the machine translation data.
ii) Segment sentences in the text.
iii) Develop an algorithm for aligning sentences across texts.
iv) Analysis syntax of sentences.
v) Building a machine translation model incorporating syntactic information.

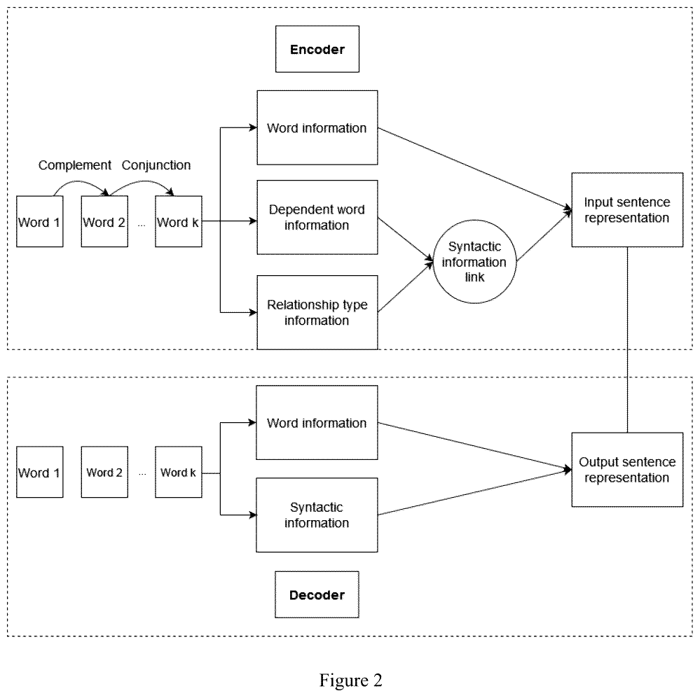

FIG. 2 provides a detailed depiction of machine translation model described in the invention.

More specifically, the method of constructing a Vietnamese machine translation model using syntactic information includes the steps:

Step 1: Collect the machine translation data.

The training data for the model is a crucial aspect in finding solutions to problems in the field of natural language processing in general and machine translation in particular. However, labeling data requires a significant amount of effort and is cost-intensive. Furthermore, there is a wealth of parallel data available from the news sources. Therefore, in this stage, the focus is on collecting published articles from reputable news sources containing Vietnamese language and other languages.

Step 2: Segment sentences in the text.

The collected text will undergo the sentence segmentation phase. The processed sentences will then serve as training data for machine translation model. The sentence detector is a method based on the linguistic feature to identify the boundary of sentences in a document. The limitation of the sentence was determined by the assumption that if the sentence ended with characters such as “.”, “;”, “!”, “?”, “ . . . ” and capitalized the following character and was not a bracket character. This is a sign of recognizing the ending position of the sentence.

Step 3: Develop an algorithm for aligning sentences across texts.

After collecting texts that are translations of each other (in step 1) and performing sentence segmentation (in the step 2), the next step involves determining which sentences are translations of each other among text pairs. The reason is that the text pairs in translation may not have same number of sentences. There may be cases where translated text omits some sentences from the original text, or the translation text splits a sentence in the original text into two or three smaller sentences. Therefore, the step focuses on developing an algorithm to find translated sentences among text pairs. Specifically, sentences in each text are passed through a large language model to generate embedding vectors. Subsequently, information retrieval tools are used to, for a given sentence in the original text, retrieve one or more sentences in translated text with the closest similarity. The similar sentence pairs will used as training data for the machine translation model.

Step 4: Analysis syntax of sentences.

The sentences, before being fed into the model training, will undergo syntactic structure analysis using dependency parsing. Specifically, dependency parsing of a sentence provides information about the relationships between words in a sentence. The relationships are determined by the current word, the dependent word and type of relationship between the two words. Each language type has its way of defining dependency parsing information, reflected in word segmentation and type of relationships between words. Firstly, sentences are tokenized, meaning identifying boundaries of words in the sentence. Tokenization is performed using the LM-LSTM-CRF machine learning model. Subsequently, the tokenized sentences undergo dependency parsing through Deep Biaffine Attention model to establish relationships between words in sentence.

Step 5: Building a machine translation model incorporating syntactic information.

At this step, the pairs of input and output translated sentences (in the step 4) are fed into the model with an architecture consisting of an Encoder and a Decoder. The encoder phase learns the dependency parsing information (in the step 4) within the input sentences. Each word in the Encoder is accompanied by the information about its dependent word and type of relationship with that dependent word. These two pieces of information are represented through word matrices and relationship type matrices to model the sentence information. The matrices are updated in training process. The Decoder phase learns syntactic information (in step 4) of the output sentences. Syntactic information is represented through randomly generated syntactic vectors during model creation, representing the syntactic roles of words in the sentences, such as subjects, predicates, etc. These syntactic vectors are updated during training process. Therefore, the machine translation will learn comprehensive syntactic information from both the input and output sentences in the training dataset.

### Example of the Invention

The proposal method has been tested using VLSP 2020 dataset for English-Vietnamese translation, comprising 20000 sentences for training, 790 sentences for testing and the VLSP 2022 dataset for Chinese-Vietnamese translation, consisting of 300000 training sentences and 1000 testing sentences.

The evaluation method uses the BLEU metric. This is a popular metric for machine translation. Besides, experiments were conducted with the conventional method commonly used for machine translation, the Transformer model, to compare the results with the proposed method.

The evaluation results for the VLSP 2020 dataset from English to Vietnamese are as follows:

| Method | BLEU |
|---|---|
| Transfomer model | 25, 20 |
| Our Method | 29, 21 |

The evaluation results for the VLSP 2022 dataset from Chinese to Vietnamese are as follows:

| Method | BLEU |
|---|---|
| Transfomer model | 31, 90 |
| Our Method | 32, 25 |

The results indicate that the proposed invention yields superior outcomes compared to methods using the Transformer model.

### THE EFFICIENCY ACHIEVED BY THE INVENTION

A notable advantage associated with this invention is the development of a method for the machine translation problem by incorporating syntactic information.

Although the descriptions include many specifics, they are not considered to limit the approach to the enforcement of patents. It is only for illustration purposes about the approach of enforcement to be a priority.

What is claimed is:

1. A method of constructing a Vietnamese machine translation model using syntactic information including:
Step 1: Collect machine translation data,
In this stage, published articles are collected from reputable news sources containing Vietnamese language and other languages;
Step 2: Segment sentences in text of the collected articles,
Text of the collected articles undergoes a sentence segmentation phase, producing processed sentences which then serve as training data for a machine translation model, the sentence detector is a method based on a linguistic feature to identify a boundary of sentences in a document, a limitation of the sentence was determined by the assumption that if the sentence ended with characters such as “.”, “;”, “!”, “?”, “ . . . ” and capitalized a following character and was not a bracket character, this is a sign of recognizing an ending position of the sentence;
Step 3: Develop an algorithm for aligning sentences across texts,
After collecting texts that are translations of each other (in step 1) and performing sentence segmentation (in the step 2), the next step involves determining which sentences are translations of each other among text pairs wherein, sentences in each text are passed through a large language model to generate embedding vectors, subsequently, information retrieval tools are used to, for a given sentence in the original text, retrieve one or more sentences in translated text with a closest similarity, the similar sentence pairs are used as training data for the machine translation model;
Step 4: Analysis syntax of sentences,
The sentences, before being fed into the model training, undergo syntactic structure analysis using dependency parsing, wherein dependency parsing of a sentence provides information about relationships between words in a sentence, the relationships are determined by a current word, a dependent word and type of relationship between the two words, each language type has its way of defining dependency parsing information, reflected in word segmentation and type of relationships between words, firstly, sentences are tokenized, meaning identifying boundaries of words in the sentence, tokenization is performed using the LM-LSTM-CRF machine learning model, subsequently, the tokenized sentences undergo dependency parsing through Deep Biaffine Attention model to establish relationships between words in a sentence;
Step 5: Building a machine translation model incorporating syntactic information,
At this step, the pairs of input and output translated sentences (in the step 4) are fed into a model with an architecture consisting of an Encoder and a Decoder, the encoder phase learns the dependency parsing information (in the step 4) within the input sentences, each word in the Encoder is accompanied by the information about its dependent word and type of relationship with that dependent word, these two pieces of information are represented through word matrices and relationship type matrices to model the sentence information, the matrices are updated in training process, the Decoder phase learns syntactic information (in step 4) of the output sentences, syntactic information is represented through randomly generated syntactic vectors during model creation, representing the syntactic roles of words in the sentences, such as subjects, predicates, etc., these syntactic vectors are updated during the training process, therefore, the machine translation will learn comprehensive syntactic information from both the input and output sentences in the training dataset.
